(19) United States
(12) Patent Application Publication
(10) Pub. No.: US 2015/0187368 A1
(43) Pub. Date: Jul. 2, 2015

(54) CONTENT REPRODUCTION CONTROL DEVICE, CONTENT REPRODUCTION CONTROL METHOD AND COMPUTER-READABLE NON-TRANSITORY RECORDING MEDIUM

(71) Applicant: CASIO COMPUTER CO., LTD., Shibuya-ku, Tokyo (JP)

(72) Inventors: Kazunori Kita, Mizhuo-cho, Nishitama-gun, Tokyo (JP); Tohru Watanabe, Ome-shi (JP); Kakuya Komuro, Hachioji-shi (JP); Toshiyuki Iguchi, Nerima-ku (JP)

(73) Assignee: CASIO COMPUTER CO., LTD., Shibuya-ku, Tokyo (JP)

(21) Appl. No.: 14/420,027

(22) PCT Filed: Jul. 23, 2013
(86) PCT No.: PCT/JP2013/004466

§ 371 Date: Feb. 6, 2015

(30) Foreign Application Priority Data
Aug. 10, 2012 (JP) 2012-178620

(51) Int. Cl. G10L 21/10; G10L 13/033; G11B 27/036; G06K 9/00; G10L 13/04; H04N 5/93

(52) U.S. Cl. CPC G10L 21/10; G10L 13/043; H04N 5/9305; G11B 27/036; G06K 9/00771; G10L 13/0335; G10L 2021/105

(57) ABSTRACT

A content reproduction control device, content reproduction control method and program thereof can cause text voice and images to be freely combined and reproduce the voice and images in synchronous to a viewer. The content reproduction control device includes text inputter for inputting text content to be reproduced as voice sound, image inputter for inputting images of a subject being caused to vocalize the text content, converter for converting the text content into voice data, generator for generating video data in which a corresponding portion relating to vocalization including the mouth of the subject has been changed, and reproduction controller causing synchronous reproduction of the voice data and the generated video data.

### TECHNICAL FIELD

The present invention relates to a content reproduction control device, a content reproduction control method and a program thereof.

### BACKGROUND ART

A display control device capable of converting arbitrary text to voice sound and outputting such in synchronous with prescribed images is known (see Patent Literature 1).

### CITATION LIST

### Patent Literature

[PTL 1]

Unexamined Japanese Patent Application Kokai Publication No. H05-313686

### SUMMARY OF INVENTION

### Technical Problem

The art disclosed in the above-described Patent Literature 1 is capable of converting text input from a keyboard into voice sound and outputting such in a synchronous manner with prescribed images. However, images are limited to those that have been prepared. Accordingly, Patent Literature 1 offers little variety from the perspective of combinations of text voice sound and images that cause this voice sound to be vocalized.

In consideration of the foregoing, it is an objective of the present invention to provide a content reproduction control device, content reproduction control method and program thereof for causing text voice sound and images to be freely combined and for reproducing the voice sound and images in a synchronous manner.

### Solution to Problem

A content reproduction control device according to a first aspect of the present invention is a content reproduction control device for controlling reproduction of content comprising: text input means for receiving input of text content to be reproduced as voice sound; image input means for receiving input of images of a subject to vocalize the text content input into the text input means; conversion means for converting the text content into voice data; generating means for generating video data, based on the image input into the image input means, in which a corresponding portion of the image relating to vocalization including a mouth of the subject is changed in conjunction with the voice data converted by the conversion means; and reproduction control means for synchronously reproducing the voice data and the video data generated by the generating means.

A content reproduction control method according to a second aspect of the present invention is a content reproduction control method for controlling reproduction of content comprising: a text input process for receiving input of text content to be reproduced as sound; an image input process for receiving input of images of a subject to vocalize the text content input through the text input process; a conversion process for converting the text content into voice data; a generating process for generating video data, based on the image input by the image input process, in which a corresponding portion of the image relating to vocalization including the mouth of the subject is changed in conjunction with the voice data converted by the conversion process; and a reproduction control process for in synchronously reproduce the voice data and the video data generated by the generating process.

A program according to a third aspect of the present invention executed by a computer that controls a function of a device for controlling reproduction of content, the program causes the computer to function as: text input means for receiving input of text content to be reproduced as voice sound; image input means for receiving input of images of a subject to vocalize the text content input into the text input means; conversion means for converting the text content into voice data; generating means for generating video data, based on the image input into the image input means, in which a corresponding portion of the image relating to vocalization including a mouth of the subject is changed in conjunction with the voice data converted by the conversion means; and reproduction control means for synchronously reproducing the voice data and the video data generated by the generating means.

### Advantageous Effects of Invention

With the present invention, it is possible to provide a content reproduction control device, content reproduction control method and program thereof for causing text voice sound and images to be freely combined and for synchronously reproducing the voice sound and images.

### BRIEF DESCRIPTION OF DRAWINGS

FIG. 1A is a summary drawing showing the usage state of a system including a content reproduction control device according to a preferred embodiment of the present invention.

FIG. 1B is a summary drawing showing the usage state of a system including a content reproduction control device according to a preferred embodiment of the present invention.

FIG. 2 is a block diagram showing a summary composition of functions of a content reproduction control device according to this preferred embodiment.

FIG. 3 is a flowchart showing process executed by a content reproduction control device according to this preferred embodiment.

FIG. 4A is a table showing the relation between characteristic and tone of voice, and between characteristic and change examples according to this preferred embodiment.

FIG. 4B is a table showing the correlation between characteristic and tone of voice, and characteristic and change examples according to this preferred embodiment.

FIG. 5 is a screen image when creating and processing video/sound data for synchronous reproduction in the content reproduction control device according to this preferred embodiment.

### DESCRIPTION OF EMBODIMENTS

Below, a content reproduction control device according to a preferred embodiment of the present invention is described with reference to the drawings.

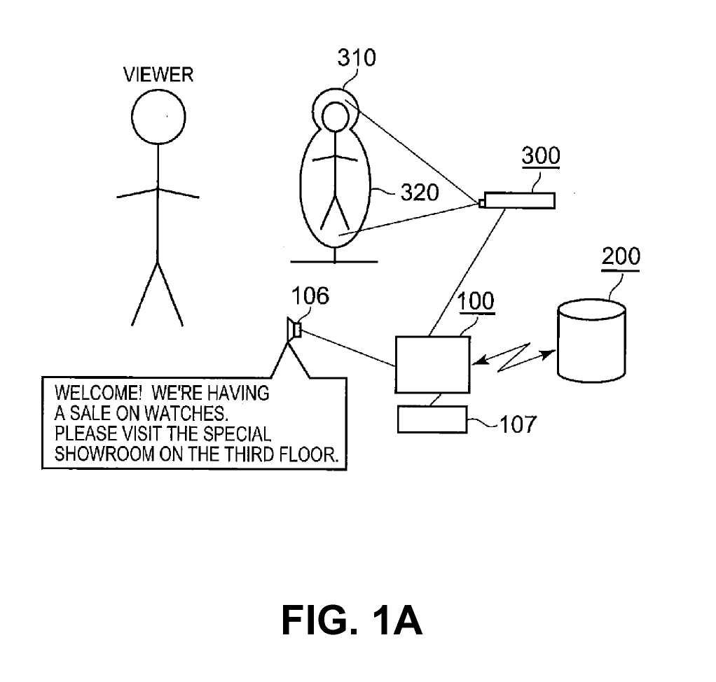

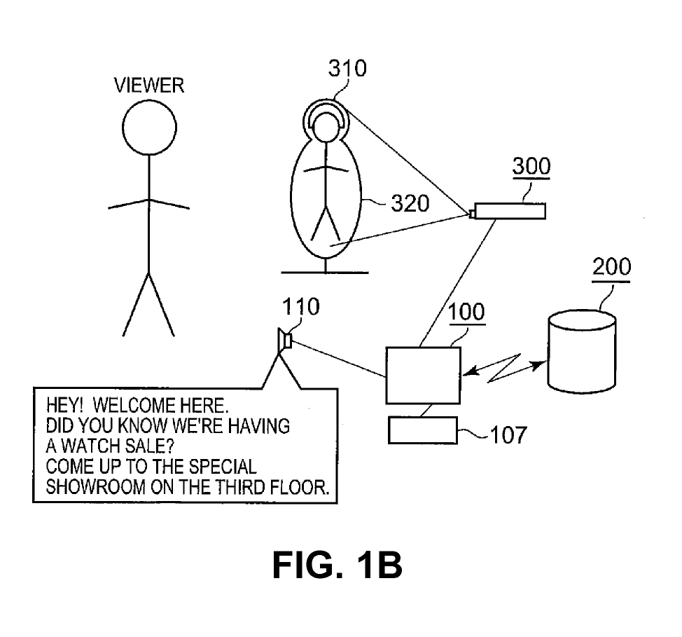

FIGS. 1A and 1B are summary drawings showing the usage state of a system including a content reproduction control device 100 according to a preferred embodiment of the present invention.

As shown in FIGS. 1A and 1B, the content reproduction control device 100 is connected to a memory device 200 that is a content supply device, for example using wireless communications and/or the like.

In addition, the content reproduction control device 100 is connected to a projector 300 that is a content video reproduction device.

A screen 310 is provided on the emission direction of the output light of the projector 300. The projector 300 receives content supplied from the content reproduction control device 100 and projects the content onto the screen 310, overlapping the content on output light. As a result, content (for example, a video 320 of a human image) created and preserved by the content reproduction control device 100 under the below-described method is projected onto the screen 310 as a content image.

The content reproduction control device 100 comprises a character input device 107 such as a keyboard, an input terminal of text data and/or the like.

The content reproduction control device 100 converts text data input from the character input device 107 into voice data (described in detail below).

Furthermore, the content reproduction control device 100 comprises a speaker 106. Through this speaker 106, voice sound of the voice data based on the text data input from the character input device 107 is output so as to be in a synchronous manner with video content (described in detail below).

The memory device 200 stores image data, for example, photo image shot by the user with a digital camera and/or the like.

Furthermore, the memory device 200 supplies image data to the content reproduction control device 100 based on commands from the content reproduction control device 100.

The projector 300 is, for example, a DLP (Digital Light Processing) (registered trademark) type of data projector using a DMD (Digital Micromirror Device). The DMD is a display element provided with micromirrors arranged in an array shape in sufficient number for the resolution (1024 pixels horizontally×768 pixels vertically in the case of XGA (Extended Graphics Array)). The DMD accomplishes a display action by switching the inclination angle of each micromirror at high speed between an on angle and an off angle, and forms an optical image through the light reflected therefrom.

The screen 310 comprises a resin board cut so as to have the shape of the projected content, and a screen filter.

The screen 310 functions as a rear projection screen through a structure in which screen film for this rear projection-type projector is attached to the projection surface of the resin board. It is possible to make visual confirmation of content projected on the screen easy even in daytime brightness or in a bright room by using, as this screen film, a film available on the market and having a high luminosity and high contrast.

Furthermore, the content reproduction control device 100 analyzes image data supplied from the memory device 200 and makes an announcement through the speaker 106 in a tone of voice in accordance with the image data thereof.

For example, suppose that the text “Welcome! We're having a sale on watches. Please visit the special showroom on the third floor” is input into the content reproduction control device 100 via the character input device 107. Furthermore, suppose that video (image) of an adult male is supplied from the memory device 200 as image data.

Accordingly, the content reproduction control device 100 analyzes the image data supplied from the memory device 200 and determines that this image data is video of an adult male.

Furthermore, the content reproduction control device 100 creates voice data so that it is possible to pronounce the text data “Welcome! We're having a sale on watches. Please visit the special showroom on the third floor” in the tone of voice of an adult male.

In this case, an adult male is projected on the screen 310, as shown in FIG. 1A. In addition, an announcement of “Welcome! We're having a sale on watches. Please visit the special showroom on the third floor” is made to viewers in the tone of voice of an adult male via the speaker 106.

In addition, the content reproduction control device 100 analyzes the image data supplied from the memory device 200 and converts the text data input from the character input device 107 in accordance with that image data.

For example, suppose that the same text “Welcome! We're having a sale on watches. Please visit the special showroom on the third floor” is input into the content reproduction control device 100 via the character input device 107. Furthermore, suppose that a facial video of a female child is supplied as the image data.

Whereupon, the content reproduction control device 100 analyzes the image data supplied from the memory device 200 and determines that the image data is a video of a female child.

Furthermore, in this example, the content playback control device 100 changes the text data of “Welcome! We're having a sale on watches. Please visit the special showroom on the third floor” to “Hey! Welcome here. Did you know we're having a watch sale? Come up to the special showroom on the third floor” in conjunction with the video of a female child.

In this case, a female child is projected onto the screen 310, as shown in FIG. 1B. In addition, an announcement of “Hey! Welcome here. Did you know we're having a watch sale? Come up to the special showroom on the third floor” is made to viewers in the tone of voice of a female child via the speaker 106.

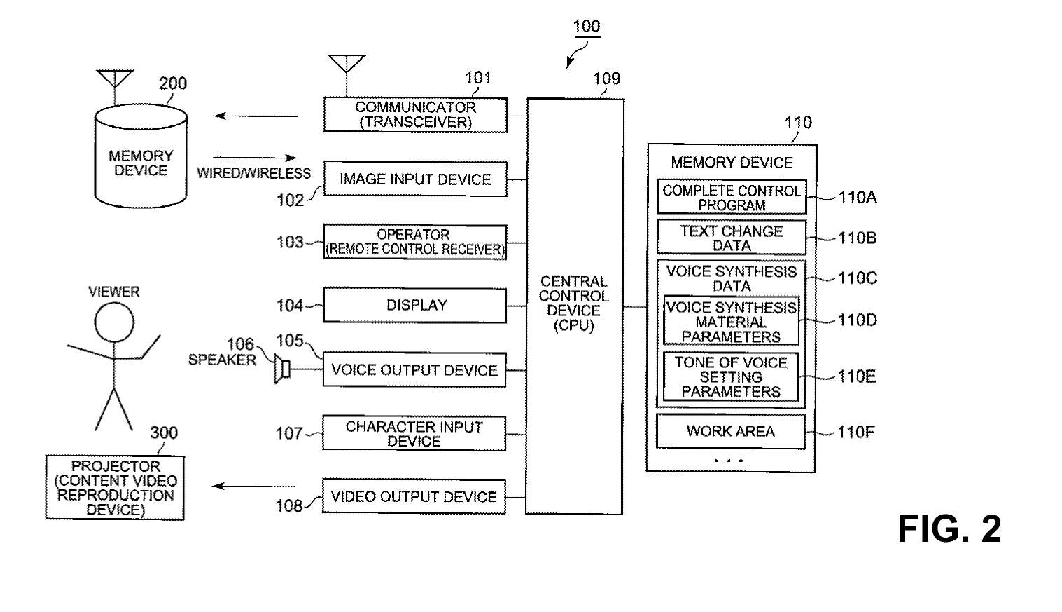

Next, the summary functional composition of the content reproduction control device 100 according to this preferred embodiment is described with reference to FIG. 2.

In this drawing, a reference number 109 refers to a central control unit (CPU). This CPU 109 controls all actions in the content reproduction control device 100.

This CPU 109 is directly connected to a memory device 110.

The memory device 110 stores a complete control program 110A, text change data 110B and voice synthesis data 110C, and is provided with a work area 110F and/or the like.

The complete control program 110A is an operation program executed by the CPU 109 and various types of fixed data, and/or the like.

The text change data 110B is data used for changing text information input by the below-described character input device 107 (described in detail below).

The voice synthesis data 110C includes voice synthesis material parameters 110D and tone of voice setting parameters 110E. The voice synthesis materials parameters 110D are data for voice synthesis materials used in the text voice data conversion process for converting text data into an audio file (voice data) in a suitable format. The tone of voice setting parameters 110E are parameters used in order to convert the tone of voice when converting the frequency component of voice data to output as voice sound (described in detail below) and/or the like.

The work area 110F functions as a work memory for the CPU 109.

The CPU 109 exerts supervising control over this content reproduction control device 100 by reading out programs, static data and/or the like stored in the above-described memory device 110 and furthermore by loading such data in the work area 110F and executing the programs.

The above-described CPU 109 is connected to an operator 103.

The operator 103 receives a key operation signal from an unrepresented remote control and/or the like, and supplies this key operation signal to the CPU 109.

The CPU 109 executes various operations such as turning on the power supply, accomplishing mode switching, and/or the like, in response to operation signals from the operator 103.

The above-described CPU 109 is further connected to a display 104.

The display 104 displays various operation statuses and/or the like corresponding to operation signals from the operator 103.

The above-described CPU 109 is further connected to a communicator 101 and an image input device 102.

The communicator 101 sends an acquisition signal to the memory device 200 in order to acquire desired image data from the memory device 200, based on commands from the CPU 109, for example using wireless communication and/or the like.

The memory device 200 supplies image data storing on itself to the content reproduction control device 100 based on that acquisition signal.

Naturally, it would be fine to send acquisition signals for image data and/or the like to the memory device 200 using wired communications.

The image input device 102 receives image data supplied from the memory device 200 by wireless communications or wired communications, and passes that image data to the CPU 109. In this manner, the image input device 102 receives input of the subject image that to be vocalized the text content from an external device (memory device 200). The image input device 100 may receive input of images through a commonly known arbitrary method, such as video input, input via the Internet and/or the like, not be restricted to through the memory device 200.

The above-described CPU 109 is further connected to the character input device 107.

The character input device 107 is for example a keyboard and, when characters are input, passes text (text data) corresponding to the input characters to the CPU 109. Through this kind of physical composition, the character input device 107 receives the input of text content that should be reproduced (emitted) as voice sound. The character input device 107 is not limited to input using a keyboard. The character input device 107 may also receive the input of text content through a commonly known arbitrary method such as optical character recognition or character data input via the Internet.

The above-described CPU 109 is further connected to a sound output device 105 and a video output device 108.

The sound output device 105 is connected to the speaker 106. The sound output device 105 converts sound data to actual voice sound and emits actual voice sound using the speaker 106, where the sound data is converted from text by the CPU 109.

The video output device 108 supplies the image data portion of video audio data compiled by the CPU 109 to the projector 300.

Next, the actions of the above-described preferred embodiment are described.

The actions indicated below are executed by the CPU 109 upon loading in the work area 110F action programs or fixed data and/or the like read from the program memory 110A as described above.

The action programs and/or the like stored as overall control programs include not only those stored at the time the content reproduction control device 100 is shipped from the factory, but also content installed by upgrade programs and/or the like downloaded over the Internet from an unrepresented personal computer and/or the like via the communicator 101 after the user has purchased the content reproduction control device 100.

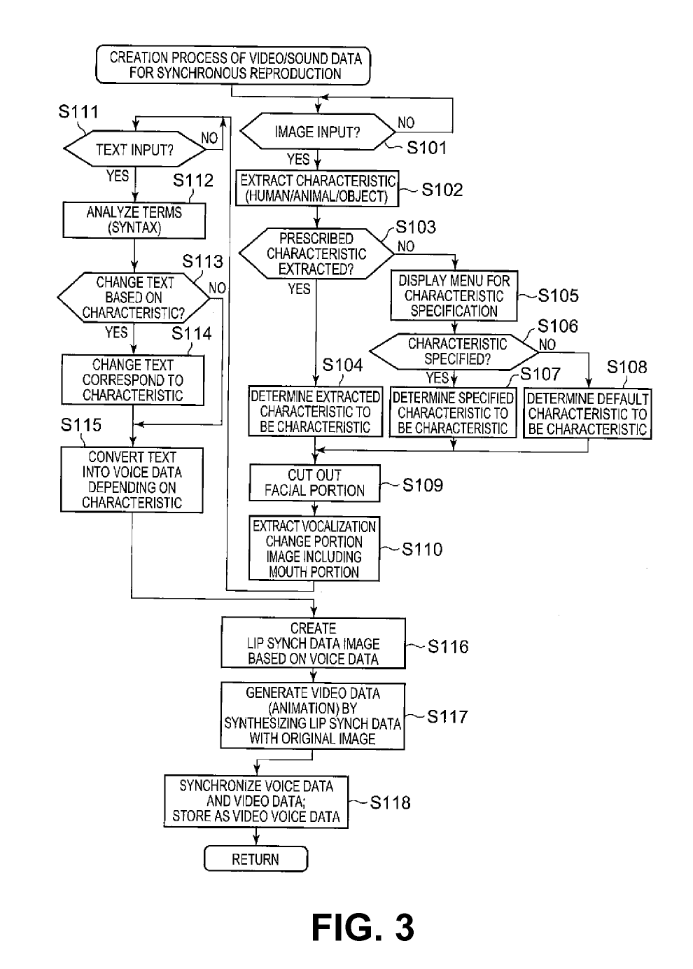

FIG. 3 is a flowchart showing the process relating to creation of video/sound data for reproduction (content) in a synchronous manner of the content reproduction control device 100 according to this preferred embodiment.

First, the CPU 109 displays on a screen and/or the like a message to promote input of images that are the subject which the user wants to vocalize voice sound, and determines whether or not image input has been done (step S101).

For image input, it would be fine to specify and input a still image and it would also be fine to specify and input a desired frozen-frame from video data.

The image of the subject is an image of a person, for example.

In addition, it would be fine for the image to be one of an animal or an object, and in this case, voice sound is vocalized by anthropomorphication (described in detail below). When it is determined that image input has not been done (step S101: No), step S101 is repeated and the CPU waits until image input is done.

When it is determined that image input has been done (step S101: Yes), the CPU 109 analyzes the features of that image and extracts characteristics of the subject from those features (step S102).

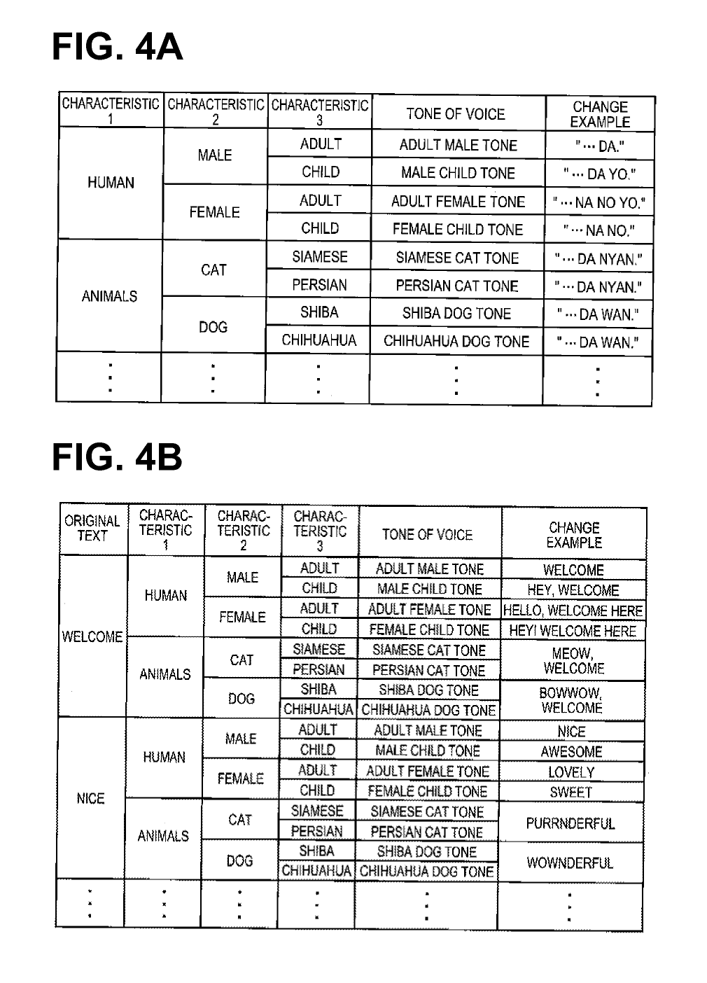

The characteristics are like characteristics 1-3 shown in FIGS. 4A and 4B, for example. Here, as characteristic 1, whether the subject is a human (person) or an animal or an object is determined and extracted.

In the case of a person, the sex and approximate age (adult or child) is further extracted from facial features. For example, the memory device 110 stores in advance images that are respective standards for an adult male, an adult female, a male child, a female child and specific animals. Furthermore, the CPU 109 extracts characteristics by comparing the input image with the standard images.

In addition, FIGS. 4A and 4B show examples in which, when it has been determined from the features of the image that the subject is an animal, detailed characteristics are extracted such as whether the animal is a dog or a cat, and the breed of cat or breed of dog is further determined

When the subject is an object, it would be fine for the CPU 109 to extract feature points of the image and create a portion corresponding to a face suitable for the object (character face).

Next, the CPU 109 determines whether or not the prescribed characteristics were extracted with at least a prescribed accuracy through the characteristics extraction process of this step S102 (step S103).

When it is determined that characteristics like those shown in FIGS. 4A and 4B have been extracted with at least a prescribed accuracy (step S103: Yes), the CPU 109 sets those extracted characteristics as characteristics related to the subject of the image (step S104).

When it is determined that characteristics like those shown in FIGS. 4A and 4B have not been extracted with at least a prescribed accuracy (step S103: No), the CPU 109 prompts the user to set characteristics by causing an unrepresented settings screen to be displayed so that characteristic are set (step S105).

Furthermore, the CPU 109 determines whether or not prescribed characteristic have been specified by the user (step S106).

When it is determined that the prescribed characteristics have been specified by the user, the CPU 109 decides that those specified characteristics are characteristics relating to the subject of the image (step S107).

When it is determined that the prescribed characteristics have not been specified by the user, the CPU 109 decides that default characteristics (for example, person, female, adult) are characteristics relating to the subject image (step S108).

Next, the CPU 109 accomplishes a process for discriminating and cutting out the facial portion of the image (step S109).

This cutting out is basically accomplished automatically using existing facial recognition technology.

In addition, the facial cutting out may be manually accomplished by a user using a mouse and/or the like.

Here, the explanation is for an example in which the process was accomplished in the sequence of deciding characteristic and then cutting out the facial image. Otherwise, it would also be fine to accomplish cutting out of the facial image and then accomplish the process of deciding characteristics from the size, position and shape and/or the like of characteristic parts such as the eyes, nose and mouth, along with the size and horizontal/vertical ratio of the contours of the face of the image.

In addition, it would be fine to use the image from the chest down as input. Otherwise, images suitable for facial images may be automatically created based on the characteristics. Thereby, the flexibility of a user's image input increases and a user's load is reduced.

Next, the CPU 109 extracts an image of parts that change based on vocalization including the mouth part of the facial image (step S110).

Here, this partial image is called a vocalization change partial image.

Besides the mouth that changes in accordance with the vocalization information, parts related to changes in facial expression, such as the eyeballs, eyelids and eyebrows are included in the vocalization change partial image.

Next, the CPU 109 promotes input of text for which the user wants vocalization of sounds and determines whether or not text has been input (step S111). When it is determined that text has not been input (step S111: No), the CPU 109 repeats step S111 and waits until text is input.

When it is determined that text has been input (step S111: Yes), the CPU 109 analyzes the terms (syntax) of the input text (step S112).

Next, the CPU 109 determines whether or not to change the input text itself t based on the above-described characteristic of the subject as a result of analysis of the terms, based on instructions selected by the user (step S113).

When instructions were not made to change the text itself based on the characteristic of the subject (step S113: No), the process proceeds to below-described step S115.

When instructions were made to change the input text based on the characteristic of the subject (step S113: Yes), the CPU 109 accomplishes a text change process correspond to the characteristics (step S114).

This text characteristic correspondence change process is a process that changes the input text into text in which at least a portion of the words are different.

For example, the CPU 109 causes the text to change by referencing the text change data 110B linked to characteristic stored in the memory device 110.

When the language that is the subject of processing is a language in which differences in characteristics of the subject discussed about are indicated by inflections, as in Japanese, this process includes a process to cause those inflections and cause the text to change into different text, for example as noted in the chart in FIG. 4A. When the language that is the subject of processing is Chinese, if a characteristic of the subject is female, for example, a process such as appending Chinese characters (YOU) indicating female is effective. In the case of English, when an characteristic of the subject is female, it would be one way to produce theatrical femininity by attaching softener, for example, appending “you know” to the end of the sentence or appending “you see?” after words of greeting. This process includes the process of causing not just the end of the word but potentially other portions of the text to be changed in accordance with the characteristics. For example, in the case of a language in which differences in characteristics of the subject are indicated by the words and phrases used, it would be fine to replace words in text sentences in accordance with a conversion table stored in the memory device 110 in advance, for example as shown in FIG. 4B. The conversion may be stored in the memory device 110 in the form of being contained in the text change data 110B in advance, in accordance with the language used.

In FIG. 4A (an example of Japanese), when the end of the input sentence is “. . . desu.” (an ordinary Japanese ending of a sentence) and the subject that is to cause the text to be produced as sound is a cat, for example, this process changes the end of the sentence to “. . . da nyan.” (Japanese ending of a sentence which indicates speaker is a cat). The table in FIG. 4B (an example of English) reflects the traditional thinking that women tend to select words that emphasize emotions, such as a woman using “lovely” where a male would use “nice”. In addition, the table in FIG. 4B reflects the traditional thinking that women tend to be more polite and talkative. In addition, this table reflects the tendency for children to use more informal expressions than adults. Furthermore, the table in FIG. 4B is designed, in the case of a dog or cat, to indicate that the subject is not a person by replacing the similar sound parts with sound of a bark, or meow or purr.

Furthermore, the CPU 109 accomplishes a text voice data conversion process (voice synthesis process) based on the changed text (step S115).

Specifically, the CPU 109 changes the text to voice data using the voice synthesis material parameters contained in the voice synthesis data 110C and the tone of voice setting parameters 110D linked to each characteristic of the subject described above, stored in the memory device 110.

For example, when the subject to vocalize the text is a male child, the text is synthesized as voice data with the tone of voice of a male child. To accomplish this, it would be fine for example for voice sound synthesis materials for adult males, adult females, boys and girls to be stored in advance as the voice synthesis data 110C and for the CPU 109 to execute voice synthesis using the corresponding materials out of these.

In addition, it would be fine for voice sound to be synthesized reflecting also the parameters such as pitch (speed) and the raising or lowering of the end of sentences, in accordance with the characteristics.

Next, the CPU 109 accomplishes the process of creating an image for synthesis by changing the image of the voice change portion described above, based on the converted voice data (step S116).

The CPU 109 creates image data for use in so-called lip synching by causing the detailed position of each part to be appropriately adjusted and changed so as to be synchronized with the voice data, based on the above-described image of the voice change portion.

In this image data for lip synching, movements related to changes in the expression of the face, such as eyeballs, eyelids and eyebrows relating to the vocalized content, besides the above-described movements of the mouth, are also reflected.

Because opening and closing of the mouth is accomplished through the use of numerous facial muscles, for example movement of the Adam's apple is striking in adult males, so it is important to cause that movement also to change depending on the characteristics.

Furthermore, the CPU 109 creates video data for the facial portion of the subject by synthesizing the image data for lip synching created for the input original image with the input original image (step S117).

Finally, the CPU 109 stores the video data created in step S117 along with the voice data created in step S115 as video/sound data (step S118).

Here, an example of text input after image input is caused was described, but prior to step S114, it would be fine for text input to be first and image input to be subsequent.

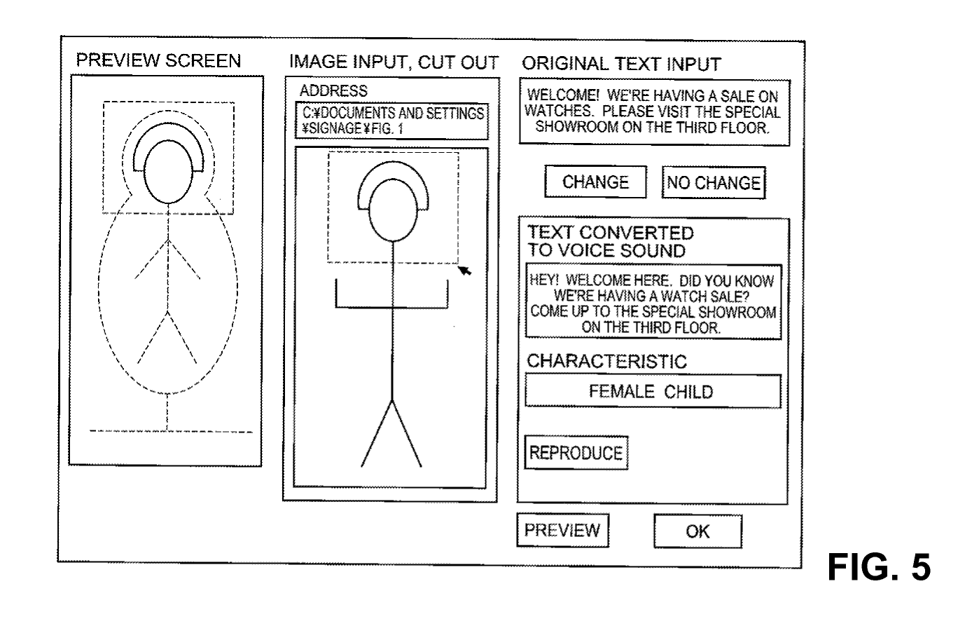

An operation screen image using to create synchronized reproduction video/sound data described above is shown in FIG. 5.

A user specifies the input (selected) image and the image to be cut out from the input image using a central “image input (selection), cut out” screen.

In addition, the user inputs the text to be vocalized in an “ original text input” column on the right side of the screen.

If a button (“change button”) specifying execution of a process for causing the text itself to change based on the characteristics of the subject is pressed (if a change icon is clicked), the text is changed in accordance with the characteristic. Furthermore, the changed text is displayed in a “text converted to voice sound” column.

When the user wishes to convert the original text into voice data as-is, the user just have to press a “no-change button”. In this case, the text is not changed and the original text is displayed in the “text converted to voice sound” column.

In addition, the user can confirm by hearing how the text converted to voice sound is actually vocalized, by pressing a “reproduction button”.

Furthermore, lip synch image data is created based on the determined characteristics, and ultimately the video/sound data is displayed on a “preview screen” on the left side of the screen. When a “preview button” is pressed, this video/sound data is reproduced, so it is possible for the user to confirm the performance of the contents.

When the video/sound data is revised, it is preferable for the user to possess a function to appropriately re-revise after confirming revision contents, although detail explanation is omitted for simplicity.

Furthermore, the content reproduction control device 100 reads the video/sound data stored in step S112 and outputs the video/sound data through the sound output device 105 and the video output device 108.

Through this kind of process, the video/sound data is output to a content video reproduction device 300 such as the projector 300 and/or the like and is synchronously reproduced with the voice sound. As a result, a guide and/or the like using a so-called digital mannequin is realized.

As described in detail above, with the content reproduced control device 100 according to the above-described preferred embodiment, it is possible for a user to select a desired image and input (select) a subject to vocalize, so it is possible to freely combine text voice and subject images to vocalize the text, and to synchronously reproduce voice sound and video.

In addition, after the characteristics of the subject that is to vocalize the input text have been determined, the text is converted to this voice data based on those characteristics, so it is possible to vocalize and express the text using a method of vocalization (tone of voice and intonation) suitable to the subject image.

In addition, it is possible to automatically extract and determine the characteristics through a composition for determining the characteristics of the subject using image recognition process technology.

Specifically, it is possible to extract sex as a characteristic, and, if the subject to vocalize is female, it is possible to realize vocalization with a feminine tone of voice and, if the subject is male, it is possible to realize vocalization with a masculine tone of voice.

In addition, it is possible to extract age as a characteristic, and, if the subject is a child, it is possible to realize vocalization with a childlike tone of voice.

In addition, it is possible to determine characteristics through designations by the user, so even in cases when extraction of the characteristics cannot be appropriately accomplished automatically, it is possible to adapt to the requirements of the moment.

In addition, conversion to voice data is accomplished after determining the characteristics of the subject to vocalize the input text and changing to text suitable to the subject image at the text stage based on those characteristics. Consequently, it is possible to not just simply have the tone of voice and intonation match the characteristics but to vocalize and express text more suitable to the subject image.

For example, if human or animal is extracted as a characteristic of the subject, and the subject is animal, vocalization is done after changing to text that personifies the animal, making it possible to realize a friendlier announcement.

In addition, it is possible for the user to set and select whether or not the text is changed with a text base, so it is possible to cause the input text to be faithfully vocalized as-is and it is also possible to cause the text to change in accordance with the characteristics of the subject and to realize vocalization with text that conveys more appropriate nuances.

Furthermore, so-called lip synch image data is created based on input images, so it is possible to create video data suitable for the input images.

In addition, at that time only the part relating to vocalization is extracted, lip synch image data is created and the original image is synthesized, so it is possible to create video data at high speed while conserving power and lightening the process.

In addition, with the above-described preferred embodiment, the video portion of content accompanying video and voice sound is reproduced by being projected onto a humanoid screen using the projector, so it is possible to reproduce the contents (advertising content and/or the like) in a manner so as to leave an impression on the viewer.

With the above-described preferred embodiment, when it was not possible to extract the characteristics of the subject with greater than a prescribed accuracy, it is possible to specify the characteristic, but regardless of whether or not it is possible to extract the characteristic, it would be fine to make it possible to specify characteristic through user operation.

With the above-described preferred embodiment, the video portion of content accompanying video and voice sound is reproduced by being projected onto a humanoid-shaped screen using the projector, but this is not intended to be limiting. Naturally it is possible to apply the present invention to an embodiment in which the video portion is displayed on a directly viewed display device.

In addition, with the above-described preferred embodiment, the content reproduction control device 100 was explained as separate from the content supply device 200 and the content video reproduction device 300.

However, it would be fine for this content reproduction control device 100 to be integrated with the content supply device 200 and/or the content video reproduction device 300. Through this, it is possible to make the system even more compact.

In addition, the content reproduction control device 100 is not limited to specialized equipment. It is possible to realize such by installing a program that causes the above-described synchronized reproduction video/sound data creation process and/or the like to be executed on a general-purpose computer. It would be fine for installation to be realized using a computer-readable non-volatile memory medium (CD-ROM, DVD-ROM, flash memory and/or the like) on which is stored in advance a program for realizing the above-described process. Or, it would be fine to use a commonly known arbitrary installation method for installing Web-based programs.

Besides this, the present invention is not limited to the above-described preferred embodiment, for the preferred embodiments may be modified without departing from the scope of the subject matter disclosed herein at the implementation stage.

In addition, the functions executed by the above-described preferred embodiment may be implemented in appropriate combinations to the extent possible.

In addition, a variety of stages are included in the preferred embodiment, and various inventions can be extracted by appropriately combining multiple constituent elements disclosed therein.

For example, even if a number of constituent elements are removed from all constituent elements disclosed in the preferred embodiment, because the efficacy can be achieved the composition with these constituent elements removed can be extracted as the present invention.

This application claims the benefit of Japanese Patent Application No. 2012-178620, filed on Aug. 10, 2012, the entire disclosure of which is incorporated by reference herein.

### REFERENCE SIGNS LIST

101 COMMUNICATOR (TRANSCEIVER)

102 IMAGE INPUT DEVICE

103 OPERATOR (REMOTE CONTROL RECEIVER)

104 DISPLAY

105 VOICE OUTPUT DEVICE

106 SPEAKER

107 CHARACTER INPUT DEVICE

108 VIDEO OUTPUT DEVICE

109 CENTRAL CONTROL DEVICE (CPU)

110 MEMORY DEVICE

110A COMPLETE CONTROL PROGRAM

110B TEXT CHANGE DATA

110C VOICE SYNTHESIS DATA

110D VOICE SYNTHESIS MATERIAL PARAMETERS

110E TONE OF VOICE SETTING PARAMETERS

110F WORK AREA

200 MEMORY DEVICE

300 PROJECTOR (CONTENT VIDEO REPRODUCTION DEVICE)

1-12. (canceled)

13. A content reproduction control device for controlling reproduction of content comprising:
a text inputter that receives input of text content to be reproduced as voice sound;
an image inputter that receives input of images of a subject to vocalize the text content input into the text inputter;
a converter that converts the text content into voice data;
a generator that generates video data, based on the image input into the image inputter, in which a corresponding portion of the image relating to vocalization including a mouth of the subject is changed in conjunction with the voice data converted by the converter; and
a reproduction controller that synchronously reproduces the voice data and the video data generated by the generator.

14. The content reproduction control device according to claim 13, further comprising:
a determiner that determines a characteristic of the subject;
wherein the converter converts the text content into voice data based on the characteristic determined by the determiner.

15. The content reproduction control device according to claim 14, wherein the converter changes the text into different text based on characteristic determined by the determiner, and converts the changed text into voice data.

16. The content reproduction control device according to claim 14, wherein:
the determiner includes a characteristic extractor that extracts the characteristic of the subject from the image through image analysis; and
the determiner determines that the characteristic extracted by the characteristic extractor is the characteristic of the subject.

17. The content reproduction control device according to claim 14, wherein:
the determiner further includes a characteristic specifier that receives specification of characteristic from the user; and
the determiner determines that the characteristic received by the characteristic specifier is the characteristic of the subject.

18. The content reproduction control device according to claim 14, wherein:
the determiner determines the sex of the subject to vocalize as an characteristic of the subject; and
the converter converts the text into voice data based on the determined sex.

19. The content reproduction control device according to claim 14, wherein:
the determiner determines the age of the subject to vocalize as an characteristic of the subject; and
the converter converts the text into voice data based on the determined age.

20. The content reproduction control device according to claim 14, wherein:
the determiner determines whether or not the subject to vocalize is a person or an animal, as an characteristic of the subject; and
the converter converts the text into voice data based on the determined results.

21. The content reproduction control device according to claim 14, wherein the converter sets a reproduction speed and converts the text content into voice data at the reproduction speed based on the characteristic determined by the determiner.

22. The content reproduction control device according to claim 13, wherein:
the generator includes an image extractor that extracts corresponding portion of the image relating to vocalization input by the image inputter; and
the generator changes the corresponding portion of the image related to vocalization extracted by the image extractor in accordance with voice data converted by the converter, and generates the video data by synthesizing the changed image with the image input by the image inputter.

23. A content reproduction control method for controlling reproduction of content comprising:
a text input process for receiving input of text content to be reproduced as sound;
an image input process for receiving input of images of a subject to vocalize the text content input through the text input process;
a conversion process for converting the text content into voice data;
a generating process for generating video data, based on the image input by the image input process, in which a corresponding portion of the image relating to vocalization including the mouth of the subject is changed in conjunction with the voice data converted by the conversion process; and
a reproduction control process for in synchronously reproduce the voice data and the video data generated by the generating process.

24. A computer-readable non-transitory recording medium that stores a program executed by a computer that controls a function of a device for controlling reproduction of content, the program causes the computer to function as a text inputter that receives input of text content to be reproduced as voice sound;
an image inputter that receives input of images of a subject to vocalize the text content input into the text inputter;
a converter that converts the text content into voice data;
a generator that generates video data, based on the image input into the image inputter, in which a corresponding portion of the image relating to vocalization including a mouth of the subject is changed in conjunction with the voice data converted by the converter; and
a reproduction controller that synchronously reproduces the voice data and the video data generated by the generator.
